(19) United States
(12) Patent Application Publication
(10) Pub. No.: US 2026/0249715 A1
(43) Pub. Date: Aug. 27, 2026

(54) VEHICLE PRE-CHARGE AND MAIN CIRCUITRY

(71) Applicant: FORD GLOBAL TECHNOLOGIES, LLC, Dearborn, MI (US)

(72) Inventors: Nicholas Patino, Okemos, MI (US); Salvin Cartier, Sterling Heights, MI (US); Sangjukta Roy Chowdhury, Fraser, MI (US); Alexander Robert Rink, Royal Oak, MI (US)

(21) Appl. No.: 19/061,438

(22) Filed: Feb. 24, 2025

(51) Int. Cl. B60L 53/16

(52) U.S. Cl. CPC B60L 53/16

(57) ABSTRACT

A vehicle power system is described, with a connector arrangement that electrically connects a power source to a load while enabling sequential coupling of pre-charge and main circuits. During connector movement, terminals defining the pre-charge circuit first establish an electrical connection before those defining the main circuit with lower impedance.

### TECHNICAL FIELD

Various embodiments relate to pre-charge circuits between a power source and high-voltage electrical components in a vehicle.

### BACKGROUND

Electrified vehicles include high-voltage components that are connected to a high-voltage bus. Electrified vehicles also include a high-voltage battery that is connected to the high-voltage bus to provide power to the high-voltage components. When the vehicle is not in an operating mode, the high-voltage battery is disconnected from the high-voltage bus. One or more main contactors may be electrically disposed between the high-voltage bus and the high-voltage battery. The main contactors are controlled to couple and decouple the high-voltage battery and the high-voltage bus.

### BRIEF DESCRIPTION OF THE DRAWINGS

FIG. 1 is an example hybrid-electric vehicle with a battery pack.

FIG. 2 is an example configuration for a vehicle high-voltage system having a pre-charge resistor.

FIG. 3 is an example timeline illustrating a pin connector sequence.

### SUMMARY

A vehicle power system is disclosed, comprising circuitry with a connector arrangement that electrically connects a power source to a load. The connector arrangement is designed such that during its movement, the terminals partially defining a pre-charge circuit establish an electrical connection before the terminals partially defining a main circuit, which has an impedance lower than that of the pre-charge circuit.

In one implementation, the terminals of the connector arrangement that partially define the pre-charge circuit are longer than those defining the main circuit. The connector arrangement may include a plug and a socket, where either the plug or the socket constitutes the portion of the connector arrangement facilitating the sequential coupling.

Once the terminals of the connector arrangement defining the main circuit are electrically coupled, portions of the pre-charge circuit and the main circuit operate in parallel. Furthermore, the pre-charge circuit incorporates a pre-charge resistor to control the current during the pre-charge phase.

A method is disclosed, comprising commanding the movement of at least a portion of a connector arrangement positioned electrically between a vehicle battery and a load. The connector arrangement includes a terminal partially defining a pre-charge circuit and a terminal partially defining a main circuit, where the main circuit has a lower impedance than the pre-charge circuit. The movement is controlled such that the pre-charge circuit is electrically completed before the main circuit is completed, enabling a controlled and sequential connection process.

In one embodiment, the method includes commanding the movement of the connector arrangement at a specified target rate. Additionally, the portion of the connector arrangement being moved may be a plug.

A vehicle is disclosed, comprising a power source, a high-voltage electrical bus, and a passthrough module that electrically connects the power source to the high-voltage electrical bus. The passthrough module includes a connector with terminal pins of varying lengths, where the longer terminal pin defines a portion of a pre-charge circuit between the power source and the high-voltage electrical bus, and the shorter terminal pin defines a portion of a main circuit between the same components.

In one embodiment, the pre-charge circuit is designed with an impedance greater than that of the main circuit, allowing for controlled current flow during the initial connection phase. The pre-charge circuit may include a resistor to further control the current. The connector may be a movable type, such as a moveable plug.

The terminal pins are arranged such that the pre-charge circuit is completed prior to the main circuit during the connection process. Once both circuits are complete, portions of the pre-charge circuit and main circuit are in parallel.

### DETAILED DESCRIPTION

When a power source with low output impedance is connected to a discharged electronic module with low input impedance, a significant inrush of current occurs. This current can affect components within the system. Additionally, the voltage difference between the output of the power source and the input of the module, combined with the low system impedance, may lead to issues during the connection process.

A high-impedance pre-charge circuit can be integrated into the module or power source in parallel with the main power circuit. This pre-charge circuit is routed through an independent terminal or series of terminals within each connector that links the power source to the module. The lengths of the terminals carrying the pre-charge circuit are deliberately adjusted relative to those carrying the main power circuit. This design provides a passive control mechanism such that the pre-charge circuit is engaged before the main power circuit during the connection process. As the connector is mated, the varying terminal lengths allow the pre-charge circuit to briefly conduct current from the power source to the module, charging the module's input to a voltage closer to the power source's output voltage. Once the pre-charge event has occurred, further mating of the connector enables the main power circuit to make contact, creating a parallel low-impedance path for power flow during normal operation. By pre-charging the module input, the inrush current is significantly reduced when the main power circuit engages.

Although systems could be designed without a pre-charge circuit by incorporating components capable of withstanding the high inrush current during the initial connection, this may necessitate the use of components that are considerably oversized. Another option involves implementing a parallel pre-charge circuit with manual controls for proper sequencing. But in this configuration, the pre-charge circuit and the main power circuit are routed through separate connectors and need to be manually connected in the correct order. A pre-charge circuit could also be combined with software controls to automate the sequencing process. In this design, software drives a relay, transistor, or another switching mechanism to delay the main power circuit's connection until the module input has been pre-charged.

Detailed embodiments are provided below. These embodiments, however, are intended solely as examples and may take various alternative forms and configurations. The accompanying figures are not drawn to scale. Certain features may be exaggerated, minimized, or omitted to highlight specific details of particular components. Consequently, the structural and functional details described herein are not to be interpreted as limiting but rather as illustrative examples to guide those skilled in the art in applying the described concepts in different ways.

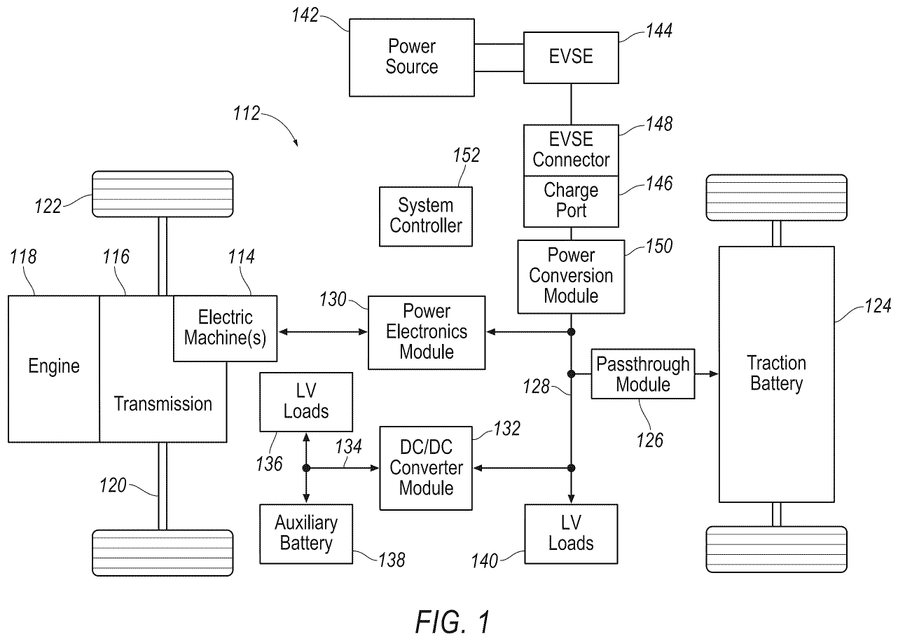

FIG. 1 illustrates an example vehicle 112, which may be a plug-in hybrid-electric vehicle (PHEV). The plug-in hybrid-electric vehicle 112 includes one or more electric machines 114 that are mechanically coupled to a gearbox or hybrid transmission 116. These electric machines 114 can function as both motors and generators. Additionally, the hybrid transmission 116 is mechanically connected to an engine 118 and a drive shaft 120, which is further coupled to wheels 122.

The electric machines 114 provide propulsion capabilities, regardless of whether the engine 118 is running. They can also operate as generators, enhancing fuel efficiency by recovering energy that would otherwise be lost as heat through a friction braking system.

The vehicle 112 may also be configured as a battery electric vehicle (BEV), in which case the engine 118 would not be present. Alternatively, the vehicle 112 could be a full hybrid-electric vehicle (FHEV) without plug-in capabilities. Another potential configuration is a fuel-cell electric vehicle (FCEV).

A power source such as a traction battery 124 stores energy that can be used by the electric machines 114. This battery may provide a high-voltage direct current (DC) output. A passthrough module 126, which may include one or more connectors, isolates the traction battery 124 from a high-voltage load bus 128 when open and connects the traction battery 124 to the load bus 128 when closed. The load bus 128 can include power and return conductors that carry current. The passthrough module 126 may be integrated with the traction battery 124.

One or more power electronics modules 130, also known as inverters, are electrically connected to the electric machines 114 and load bus 128. These modules facilitate the bi-directional transfer of energy between the traction battery 124 and the electric machines 114. For example, while the traction battery 124 provides DC voltage, the electric machines 114 typically require three-phase alternating current (AC) for operation. The power electronics module 130 converts the DC voltage to AC for propulsion and, in regenerative mode, converts the AC generated by the electric machines 114 back into DC to recharge the traction battery 124.

In addition to powering propulsion systems, the traction battery 124 supplies energy to other electrical systems in the vehicle 112. A DC/DC converter module 132 converts the high-voltage DC from the load bus 128 to a low-voltage DC level suitable for low-voltage load bus 134, which powers low-voltage loads 136. The converter module 132 can also charge an auxiliary battery 138, such as a 12V battery, which is connected to the load bus 134. The low-voltage loads 136 draw power from the auxiliary battery 138, while high-voltage loads 140, such as fans, electric heating elements, or air-conditioning compressors, connect directly to the load bus 128 and are controlled by dedicated controllers.

The vehicle 112 may also recharge the traction battery 124 from an external power source 142. This source could be an electrical outlet or an electric power distribution network managed by a utility company. The external power source 142 connects to the vehicle 112 through electric vehicle supply equipment (EVSE) 144, which includes circuitry and controls to manage energy transfer. The EVSE 144 may provide either AC or DC power and connect to the vehicle's charge port 146 using a charge connector 148. The charge port 146 interfaces with an on-board charger 150 that conditions the incoming power for the traction battery 124 and load bus 128. Alternatively, some systems may use wireless inductive coupling for power transfer, eliminating the need for physical connectors.

Electronic modules within the vehicle 112 may communicate through one or more vehicle networks, which can include multiple channels for data transfer. One channel may include a serial bus, such as a Controller Area Network (CAN). Another channel could be an Ethernet network based on the IEEE 802 family of standards. Additional channels may involve discrete connections between modules and may also include power signals sourced from the auxiliary battery 138.

Different types of signals are routed over specific channels based on their requirements. For instance, video signals may be transmitted over a high-speed channel, such as Ethernet, while control signals may utilize CAN or discrete connections. The vehicle network comprises both hardware and software components that facilitate signal and data exchange among the modules. Although not depicted in FIG. 1, the vehicle network can be assumed to connect to any electronic modules within the vehicle 112.

Additionally, a Vehicle System Controller (VSC) 152 (e.g., one or more controllers) may be included to coordinate the operation of various components throughout the vehicle.

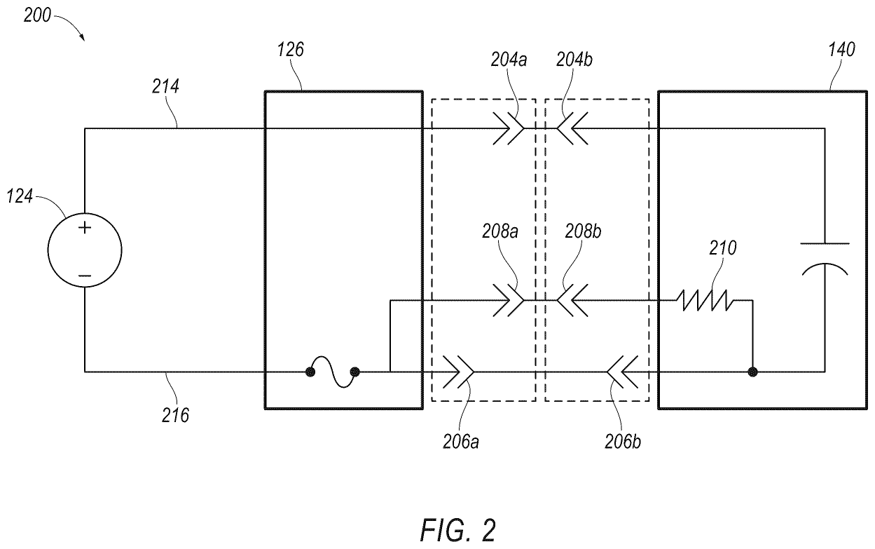

FIG. 2 shows a circuit diagram depicting a configuration of a high-voltage power distribution system of the vehicle 112 having a power supply circuit 200. The power supply circuit 200 includes an electrical connection to positive and negative terminals 214, 216 of the traction battery 124. The power supply circuit 200 includes a plurality of terminals 204a, 204b, 206a, 206b, 208a, 208b for coupling the traction battery 124 to, in this example, the high-voltage loads 140. These arrangements, however, may be used with other loads (e.g., the electric machines 114, etc.). Specifically, the passthrough module 126 may be connected to the high-voltage loads 140 via the plurality of terminals 204a, 204b, 206a, 206b, 208a, 208b.

The power supply circuit 200 includes further subcircuits which are selectively coupled by the system controller 152. In this example, the power supply circuit 200 includes a main circuit defined by the circuit path connected by the terminals 204a, 204b, 206a, 206b. The power supply circuit 200 further includes a pre-charge circuit defined by the circuit path connected by the terminals 204a, 204b, 208a, 208b. As shown, portions of the pre-charge circuit are parallel to portions of the main circuit when both are complete.

The high-voltage loads 140, in this example, include a pre-charge resistor 210 on the pre-charge circuit. The pre-charge resistor 210 limits the current flowing through the power supply circuit 200 during startup when the traction battery 124 is initially connected to the high-voltage loads 140. As such, the pre-charge circuit has a higher impedance than the main circuit. That is, when the pre-charge circuit is closed prior to the main circuit, the flow of current may redirect from the pre-charge circuit to the main circuit upon connection of the main circuit as a result of the lower impedance provided by the main circuit.

The terminals 204a, 206a, 208a (e.g., pins) may be part of an electrical connector such as a plug connector or pin connector. Likewise, the terminals 204b, 206b, 208b (e.g., pin receptacles) may be the other part of the electrical connector (e.g., the socket or other half of the electrical connector). In one example, the pins 204a, 208a are longer than the pin 206a such that when engaging the pin receptacles 204b, 206b, 208b, the pins 204a, 208a establish electrical contact with the pin receptacles 204b, 208b prior to the pin 206a establishing electrical contact with the pin receptacle 206b.

The controller 152 may cause parts of the electrical connector to move towards each other to couple (e.g., mate to form an electrical connection) by known operation of an actuator. The actuator may receive commands from the controller 152 and physically cause one or both parts of the electrical connector to move. For example, the actuator may be an electro-mechanical motor configured to move the part of the connector fixedly carrying the terminals 204a, 206a, 208a. In this way, the controller 152 sequentially completes the pre-charge circuit and then the main circuit. In another embodiment, a user, rather than the controller 152 may cause parts of the electrical connector to move towards each other to couple. Therefore, during manual assembly, the pre-charge circuit may be connected by a user.

The high-voltage loads 140 may effectively include capacitive elements. The pre-charge operation may limit large initial current flows (e.g., inrush currents) that can occur when switching a voltage to such capacitive loads.

At system power-up for example, the terminals 204a through 208b are open. That is, the traction battery 124 is decoupled or isolated from the load bus 128. As a result of movement of the connector described above, the pre-charge operation is performed before the main circuit is established.

The duration of the pre-charge operation can depend on the relative lengths of the terminals and the rate of movement of the connector. Faster movement would shorten the pre-charge duration. The controller 152 may therefore command movement of the connector at different rates depending on circumstances including state of charge, type of load to be connected (e.g., loads the exhibit primarily capacitive behavior), etc. A high state of charge of the traction battery 124 may require a longer pre-charge duration.

The controller 152 may further adjust the lengths of the pins using known actuators. For example, the controller 152 may actuate the terminals 204a, 208a to extend them further such that the difference in length relative to the terminal 206a increases, thereby increasing the length of time the terminals 208a, 208b are coupled prior to the terminals 206a, 206b being coupled.

The power supply circuit 200 may include a battery-side voltage sensing device that is coupled between the terminals 214, 216. For example, the voltage sensing device may be a voltage sensor or a resistive network that scales the voltage levels to be compatible with the controller 152. The voltage sensing device may also include circuitry for filtering the voltage signals. The controller 152 may receive a signal from the battery-side voltage sensing device that is indicative of the traction battery voltage.

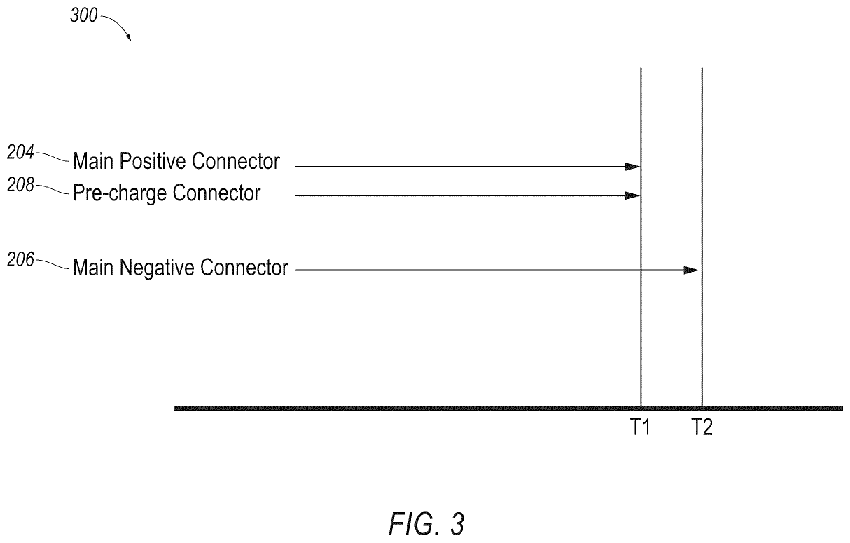

FIG. 3 shows a timeline illustrating the order in which the terminals 204a through 208b are connected in response to a command to close the power supply circuit 200. Mechanical pin sequencing is the staggering of engagement points of respective terminal connections (e.g., contacts). Due to their longer length for example, the terminals 204a, 204b, 208a, 208b may respectively establish electrical contact before the terminals 206a, 206b.

In this example, the controller 152 begins moving one or both parts of the connector in response to a command to close the power supply circuit 200. At time T1, the terminals 204a, 204b, 208a, 208b respectively establish electrical contact. At time T2, the terminals 206a, 206b establish electrical contact. The difference between times T1 and T2 represents the pre-charge time associated with the circuit 200.

Computing devices, like the controllers suggested above, generate commands that can be executed to carry out the processes outlined. These computer-executable commands may be compiled or interpreted from programs created using various programming languages and technologies, including, but not limited to, Java™, C, C++, Python, Julia, SCALA, Visual Basic, JavaScript, Perl, and HTML. Typically, a processor (e.g., a microprocessor) receives these commands from a memory or another computer-readable medium and executes them, thereby performing one or more processes, including those described herein. Such commands, along with other data, may be stored in files and transmitted through various computer-readable media. In computing, a file is generally a collection of data stored on a computer-readable medium, such as a storage drive or random-access memory.

A computer-readable medium (also referred to as a processor-readable medium) is any non-transitory (i.e., tangible) medium that provides data, including instructions, which can be read by a processor of a computing device. This medium can take many forms, including non-volatile media (e.g., storage drives) and volatile media (e.g., RAM). Instructions may also be transmitted through transmission media such as fiber optics, wired connections, or wireless communication systems, including internal system buses connected to the processor of a computing device. Common examples of computer-readable media include RAM, PROM, EPROM, FLASH-EEPROM, memory chips or cartridges, or any other medium that a computing device can read.

While exemplary embodiments have been described above, these embodiments are not intended to encompass all possible implementations. The language used in the specification serves as a description rather than a limitation, and various modifications may be made without departing from the spirit and scope of the subject matter described. Additionally, features from different embodiments may be combined to create further implementations within the scope of the claims.

What is claimed is:

1. A vehicle power system comprising:
circuitry, including a connector arrangement, configured to electrically connect a power source and a load such that as a result of movement of at least some of the connector arrangement, terminals of the connector arrangement partially defining a pre-charge circuit electrically couple before terminals of the connector arrangement partially defining a main circuit, having an impedance less than the pre-charge circuit, electrically couple.

2. The vehicle power system of claim 1, wherein at least some of the terminals of the connector arrangement partially defining the pre-charge circuit are longer than the terminals of the connector arrangement partially defining the main circuit.

3. The vehicle power system of claim 1, wherein the connector arrangement includes a plug and a socket.

4. The vehicle power system of claim 3, wherein the at least some of the connector arrangement is the plug or socket.

5. The vehicle power system of claim 1, wherein after the terminals of the connector arrangement partially defining the main circuit are electrically coupled, portions of the pre-charge circuit and main circuit are in parallel.

6. The vehicle power system of claim 1, wherein the pre-charge circuit includes a pre-charge resistor.

7. A method comprising:
commanding movement of at least a portion of a connector arrangement, that is electrically between a vehicle battery and a load and that carries a terminal that partially defines a pre-charge circuit and a terminal that partially defines a main circuit having an impedance less than the pre-charge circuit, such that the pre-charge circuit is completed and then the main circuit is completed.

8. The method of claim 7, wherein the commanding includes commanding movement at a target rate.

9. The method of claim 7, wherein the at least a portion of the connector arrangement is a plug.

10. A vehicle comprising:
a power source;
a high-voltage electrical bus; and
a passthrough module configured to connect the power source and high-voltage electrical bus, and including a connector with terminal pins of different lengths such that a longer of the terminal pins defines a portion of a pre-charge circuit between the power source and high-voltage electrical bus and a shorter of the terminal pins defines a portion of a main circuit between the power source and high-voltage bus.

11. The vehicle of claim 10, wherein the pre-charge circuit is configured such that an impedance of the pre-charge circuit is greater than an impedance of the main circuit.

12. The vehicle of claim 11, wherein the pre-charge circuit includes a resistor.

13. The vehicle of claim 10, wherein the connector is a moveable connector.

14. The vehicle of claim 13, wherein the terminal pins are configured such that the longer of the terminal pins achieves electrical connection before the shorter of the terminal pins.

15. The vehicle of claim 10, wherein the connector is a plug.

16. The vehicle of claim 10, wherein the pre-charge circuit and main circuit are configured such that portions of the pre-charge circuit and main circuit are in parallel when both are complete.
